(19) United States
(12) Patent Application Publication
(10) Pub. No.: US 2014/0050962 A1
(43) Pub. Date: Feb. 20, 2014

(54) COMPACT RECHARGEABLE BATTERY - SCREW CONNECTION OF CELL HOLDERS

(71) Applicant: C. & E. Fein GmbH, Schwaebisch Gmuend - Bargau (DE)

(72) Inventor: Klaus JUSTINSKI, Schechingen (DE)

(73) Assignee: C. & E. Fein GmbH, Schwaebisch Gmuend - Bargau (DE)

(21) Appl. No.: 13/966,545

(22) Filed: Aug. 14, 2013

(30) Foreign Application Priority Data
Aug. 16, 2012 (DE) 10 2012 107 532.8

(51) Int. Cl. H01M 2/10

(52) U.S. Cl. CPC H01M 2/1022
USPC 429/100

(57) ABSTRACT

A cell holder for supporting battery cells, particularly rechargeable battery cells, inside a rechargeable battery housing of an electric power tool includes: a first cell holder half and a second cell holder half, wherein the first cell holder half is connected or connectable to the second cell holder half by a connector in a detachable or non-detachable way, wherein the first cell holder half has a first contact surface and an adjoining first surface and the second cell holder half has a second contact surface and an adjoining second surface, wherein the first contact surface is formed with a first oversize raised from the first surface and/or the second contact surface is formed with a second oversize raised from the second surface, wherein in the connected state the first contact surface rests on the second contact surface and the first surface is arranged opposite the second surface.

### FIELD OF THE INVENTION

The present invention relates to a cell holder for supporting battery cells, particularly rechargeable battery cells, inside a rechargeable battery housing of an electric power tool.

### BACKGROUND OF THE INVENTION

In prior art cell holders for battery cells and/or accumulator cells (rechargeable battery cells) are known, which fixate/support/hold rechargeable battery cells inside the housing of a rechargeable battery pack of an electric power tool (for example of an oscillating electric power tool).

### SUMMARY OF THE INVENTION

Cell holders for rechargeable battery cells can essentially consist of two parts (cell holder halves), wherein said parts can be structural components made of plastic material. Said cell holder halves can, for example by the arrangement of several screw connections, be connected to each other in order to allow for a stable support of the rechargeable battery cells to be accommodated. A screw connection however requires a substantial amount of space. The number of screw connections should therefore be as low as possible. If however too few connection points are provided, the cell holder halves can at least in particular areas gape open.

One object of the invention is therefore to provide a way of connecting cell holder halves, which requires as few connecting means as possible and yet still prevents a gaping of the connected cell holder halves.

As a first embodiment of the invention a cell holder for supporting battery cells, particularly rechargeable battery cells, inside a rechargeable battery housing of an electric power tool is provided, comprising: a first cell holder half and a second cell holder half, wherein the first cell holder half is connected or connectable to the second cell holder half by a connecting means in a detachable or non-detachable way, wherein the first cell holder half has a first contact surface and an adjoining first surface and the second cell holder half has a second contact surface and an adjoining second surface, wherein the first contact surface is formed with a first oversize raised from the first surface and/or the second contact surface is formed with a second oversize raised from the second surface, wherein in the connected state the first contact surface rests on the second contact surface and the first surface is arranged opposite the second surface.

By pressing together two opposing surfaces of the cell holder halves an inserted battery cell can be pressed/clamped into the cell holder and/or additional contact areas can be pressed together, whereby a gaping of the assembled cell holder can be prevented.

Exemplary embodiments are described in the dependent claims. According to an exemplary embodiment of the invention a cell holder is provided, wherein in the connected state at least with battery cells not inserted the first cell holder half is tilted to the second cell holder half and/or the first cell holder half has a third surface and the second cell holder half has a fourth surface, wherein the third surface can be pressed or brought into contact with the fourth surface.

In total a tilting towards each other of the complementary cell holder halves can result, which ensures that an inserted battery is clamped in the cell holder and thus mechanically fixated and/or wherein additional contact areas are pressed together and as a result noise generation or damage through loosely fitting contact areas can be eliminated.

In a further exemplary embodiment according to the invention a cell holder is provided, wherein the first contact surface, the first surface and the third surface are different from each other and/or wherein the second contact surface, the second surface and the fourth surface are different from each other.

According to a further exemplary embodiment of the present invention, a cell holder is provided, wherein the first and/or the second oversize are in the range between 0.1 mm and 1 mm, particularly in the range between 0.3 mm and 0.7 mm, and/or the first and/or the second oversize is 0.5 mm.

By the use of an oversize in the range between 0.1 mm and 1 mm, particularly in the range between 0.3 mm and 0.7 mm, or by the use of an oversize of 0.5 mm, respectively, a beneficial tilt of the cell holder halves towards each other and/or a pressing together of complementary contact areas of the cell holder halves can be achieved without creating too great a tension and thus too great a mechanical stress of the cell holder halves, which could lead to a breakage.

According to an exemplary embodiment of the invention a cell holder is provided, wherein the first and the second contact surface have a distance from the means of connection, wherein said distance is in the range between 1 mm and 20 mm, particularly in the range between 2 mm and 10 mm and more particularly in the range between 3 mm and 5 mm.

By the use of a distance, particularly between 1 mm and 20 mm, particularly in the range between 2 mm and 10 mm and more particularly in the range between 3 mm and 5 mm a beneficial tensioning/clamping of complementary contact areas and/or tilt of the cell holder halves can be reached.

In a further embodiment according to the invention a cell holder is provided, wherein the connecting means is a screw, a rivet, a threaded rod, a clip-on connection a or clamping connection.

By using a screw, a rivet, a threaded rod, a clip-on connection or a clamping connection a cost-efficient way of connecting is implemented.

According to a further exemplary embodiment of the present invention a cell holder is provided, wherein the first and/or the second cell holder half has a lug, which engages in a groove of the second and/or the first cell holder half.

By using one or multiple lug/groove combinations of complementary cell holder halves a lock against rotation during assembly by the connecting means and/or a centering/alignment of the cell holder halves to one another can be enabled. According to an exemplary embodiment of the invention a cell holder is provided, wherein the lug is the first contact surface and the groove is the second contact surface.

Due to a dual role of the lug/groove combination a cost-efficient lock against rotation/alignment/centering of the cell holder halves and a clamping/tensioning of otherwise loosely fitting complementary contact areas and/or a mechanical fixation of batteries inserted in the cell holder can be ensured.

It can be considered an idea of the invention to provide cell holder halves which are formed in such a way, that as few screw connections as possible are arranged on them and yet the screwed together cell holders do not gape open. Here the cell holder halves are formed in such a way, that by the screw connection for example complementary contact areas of the cell holder halves, in whose vicinity no direct screw connection is present, are pressed together in such a way that they don't gape open.

The individual features can of course also be combined with each other, which may in part also lead to beneficial effects surpassing the total effects of individual features.

### SHORT DESCRIPTION OF THE DRAWINGS

Further details and benefits of the invention are made clear by means of the exemplary embodiments shown in the drawings. It is shown by

FIG. 1 a perspective view of a single row cell block,

FIG. 2 a lateral view of the cell block with a longitudinal section view of a lower area X,

FIG. 3 area X in longitudinal section view,

FIG. 4 area X as an exploded view.

### DETAILED DESCRIPTION OF EXEMPLARY EMBODIMENTS

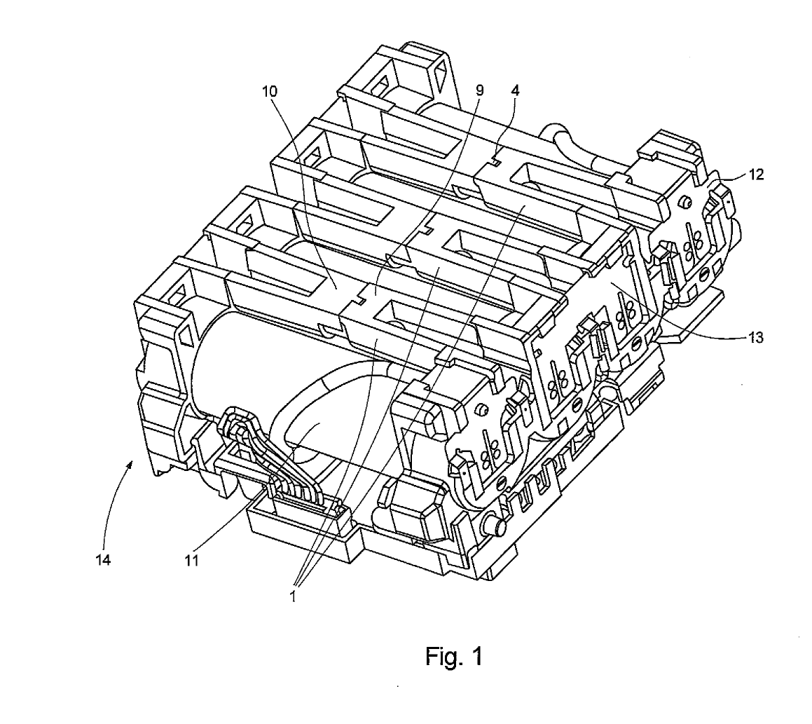

FIG. 1 shows a single row rechargeable battery block with ribs 1 for connecting the two cell holder halves of a cell holder. The rechargeable battery block has a plurality of rechargeable battery cells 11 and/or battery cells, which are connected in series via electrical contacts, cell connectors 12, 13. The individual rechargeable battery cells 11 are held by cell holders 14, which were for example made from plastic material. The cell, holders 14 can be assembled from two, three or more cell holder halves 9, 10. The cell holder halves 9, 10 are connected by a screw. In order to prevent a shifting/rotating of the two cell holder halves 9, 10 to each other, lugs 4 are arranged, which can engage in corresponding grooves of the complementary cell holder half.

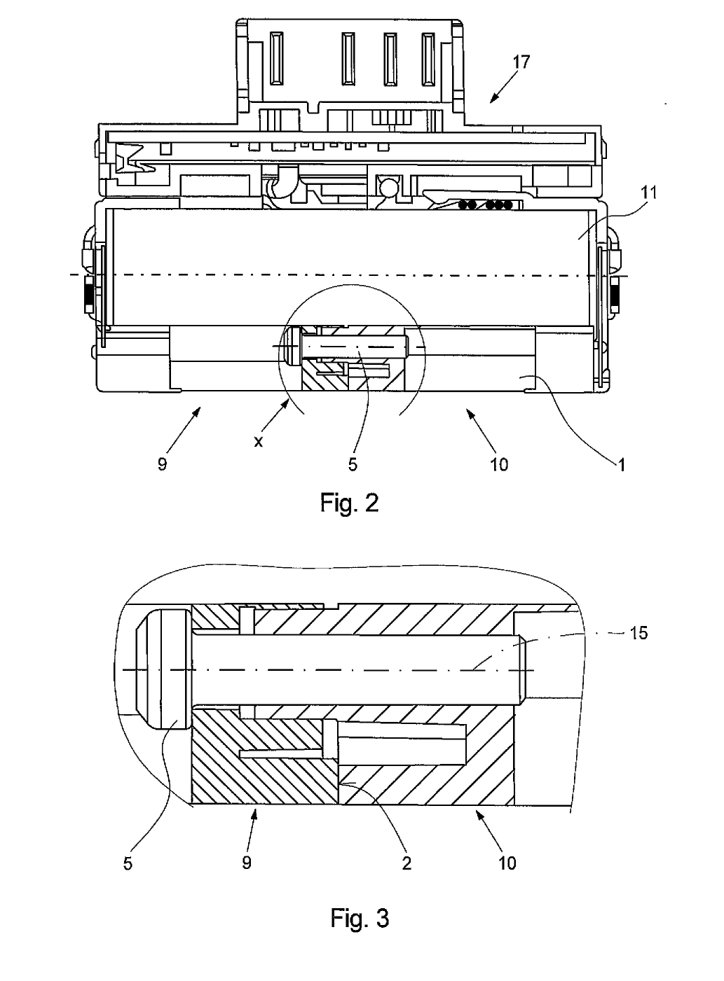

FIG. 2 shows a cell holder with a rechargeable battery 11, wherein the cell holder consists of two cell holder halves 9, 10. The two cell holder halves 9, 10 are connected to each other by a screw 5.

FIG. 3 shows detail X with the screw 5 for connecting the cell holder halves 9, 10. Here according to the invention a surface 2 of the cell holder half 9 is formed which is raised from its surroundings, and which is pressed onto the corresponding opposite surface of the cell holder half 10 in such a way, that for example in an area 17 located distantly from the screw connection with the screw 5 the contact areas of the cell holder halves 9, 10 are pressed together (assuming that in said area 17 complementary surfaces of the cell holder halves are present, which can be brought into contact). By way of this a gaping open of the contact areas of the cell holder halves for example in said area 17 is prevented.

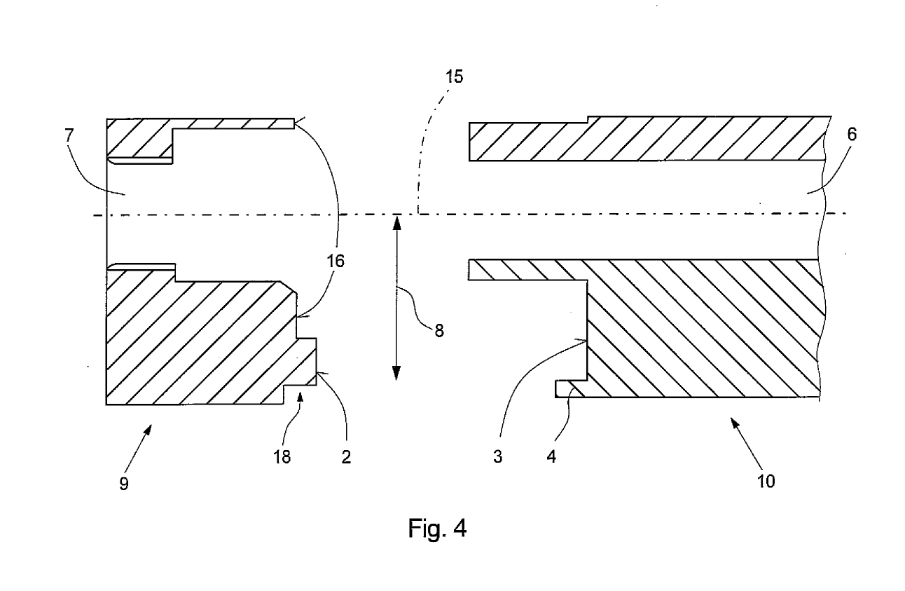

FIG. 4 shows in an exploded view in each case a portion of the cell holder halves 9, 10. For example the cell holder half 10 can have a lug 4 engaging in a groove 18 of the complementary cell holder half 9. By way of this lug/groove connection a centering/lock against rotation during assembly/screwing together of the two cell holder halves is ensured. Through a cylindrical recess 6, 7 a screw can be passed, which can hold the two cell holder halves together. If said screw connection, which can for example be arranged below the rechargeable battery cells to be supported, is the only connection of the two cell holder halves 9, 10, said cell holder halves 9, 10 can for example gape apart above the rechargeable battery cells and/or oscillate/vibrate during operation of an electric power tool. In order to avoid this, the cell holder half 9 for example has a raised surface/elevation 2, wherein said elevation 2 has a slight oversize with respect to the base surface 16, for example 0.5 mm. After establishing the screw connection said surface 2 is pressed onto the surface 3 and leads to a tensioning of the cell holder halves 9, 10, by which the cell holder halves 9, 10 are pressed together at additional contact areas, which is beneficial particularly at contact areas located more distantly from the screw connection. By said pressing together of the contact areas a gaping of the contact areas is prevented. In order to create such a beneficial tensioning of the cell holder halves 9, 10 to each other, a distance 8 of the screw connection and/or the longitudinal axis 15 to the surface 2 is beneficially to be kept. The greater said distance 8 is, the more strongly other contact areas of the cell holder halves are pressed together. Thus due to the elevation 2, after screwing, the two cell holder halves 9, 10 are tilted/sloped towards each other, by which the corresponding complementary cell holder halves 9, 10 are pressed together and/or by which inserted rechargeable battery cells are mechanically clamped and thus fixated. In an alternative embodiment a tensioning according to the invention can also be achieved by a lug/groove arrangement. In said alternative embodiment the lug/groove arrangements serve a dual purpose, i.e. a lock against rotation, particularly during screwing together, and an avoiding of gaping open of connected cell holder halves.

It shall be mentioned that the term “comprise” does not preclude further elements or process steps, just as the term “a” and “an” does not preclude multiple elements and steps.

The reference numerals used serve only to increase understandability and should in no case be considered limiting, wherein the scope of protection of the invention is expressed by the claims.

### LIST OF REFERENCE NUMERALS

1 rib

2 contact surface

3 contact surface

4 lug

5 screw

6 recess for screw

7 recess for screw

8 distance

9 cell holder half

10 cell holder half

11 rechargeable battery cell

12 cell connector

13 cell connector

14 cell holder

15 center line

16 surface

17 area

18 groove

1. A cell holder for supporting battery cells, particularly rechargeable battery cells, inside a rechargeable battery housing of an electric power tool, comprising
a first cell holder half (9) and
a second cell holder half (10), wherein the first cell holder half (9) is connected or connectable to the second cell holder half (10) by a connecting means (5) in detachable or non-detachable way, wherein the first cell holder half (9) has a first contact surface (2) and an adjoining first surface (16) and the second cell holder half (10) has a second contact surface (3) and an adjoining second surface,
wherein
the first contact surface (2) is formed with a first oversize raised from the first surface (16) and/or the second contact surface (3) is formed with a second oversize raised from the second surface, wherein in the connected state the first contact surface (2) rests on the second contact surface (3) and the first surface (16) is arranged opposite the second surface.

2. The cell holder according to claim 1, wherein in the connected state at least with battery cells not inserted the first cell holder half (9) is tilted to the second cell holder half (10) and/or the first cell holder half (9) has a third surface and the second cell holder half (10) has a fourth surface, wherein the third surface can be pressed or brought into contact with the fourth surface.

3. The cell holder according to claim 1, wherein the first contact surface (2), the first surface (16) and the third surface are different from each other and/or wherein the second contact surface (3), the second surface and the fourth surface are different from each other.

4. The cell holder according to claim 1, wherein the first and/or the second oversize are in the range between 0.1 mm and 1 mm, particularly in the range between 0.3 mm and 0.7 mm, and/or the first and/or the second oversize is 0.5 mm.

5. The cell holder according to claim 1, wherein the first and the second contact surface (2, 3) have a distance (8) from the means of connection (5), wherein said distance (8) is in the range between 1 mm and 20 mm, particularly in the range between 2 mm and 10 mm and more particularly in the range between 3 mm and 5 mm.

6. The cell holder according to claim 1, wherein the means of connection (5) is a screw, a rivet, a threaded rod, a click-on connection or a clamping connection.

7. The cell holder according to claim 1, wherein the first and/or the second cell holder half (9, 10) has a lug (4), which engages in a groove (18) of the second and/or first cell holder half (10, 9).

8. The cell holder according to claim 1, wherein the lug (4) is the first contact surface and the groove (18) is the second contact surface.
